(19) United States
(12) Patent Application Publication
(10) Pub. No.: US 2016/0277111 A1
(43) Pub. Date: Sep. 22, 2016

(54) FIBER OPTIC ASSEMBLIES FOR TAPPING LIVE OPTICAL FIBERS IN FIBER OPTIC NETWORKS EMPLOYING PARALLEL OPTICS

(71) Applicant: CORNING OPTICAL COMMUNICATIONS LLC, Hickory, NC (US)

(72) Inventors: Scott Eaker Buff, Hickory, NC (US); Terry Lee Cooke, Hickory, NC (US); Brian Keith Rhoney, Hickory, NC (US)

(21) Appl. No.: 15/172,470

(22) Filed: Jun. 3, 2016

Related U.S. Application Data
(63) Continuation of application No. PCT/US14/67904, filed on Dec. 1, 2014.
Application No. PCT/US14/67904 is a continuation of application No. 14/099,003, filed on Dec. 6, 2013, now abandoned.

(51) Int. Cl. H04B 10/25; G02B 6/38; G02B 6/42; H04B 10/27; G02B 6/43

(52) U.S. Cl. CPC H04B 10/25; H04B 10/27; G02B 6/43; G02B 6/4286; G02B 6/3879

(57) ABSTRACT

A fiber optic assembly for supporting optical connections in a fiber optic network employing parallel optical configurations is described. In one embodiment, the fiber optic assembly includes at least two live multi-fiber components and at least one tap multi-fiber component. Optical signals are routed from one live multi-fiber component to another in a parallel optical connection configuration, with each group of optical signals corresponding to a respective group of fiber positions on each live multi-fiber component. Each group of optical signals is also routed to one of the first and second groups of fiber positions of the at least one tap multi-fiber component in a parallel optical connection configuration. In this manner, fiber optic signals can be simultaneously provided and monitored within an active fiber optic network using a parallel optical configuration without the need for interrupting network operations.

### PRIORITY APPLICATION

This application is a continuation of International Patent Application Serial No. PCT/US14/67904, filed on Dec. 1, 2014, designating the United States of America which claims the benefit of priority to U.S. application Ser. No. 14/099,003 filed on Dec. 6, 2013, the content of both of which is relied upon and incorporated herein by reference in their entirety.

### BACKGROUND

1. Field

The disclosure relates generally to providing fiber optic connections in fiber optic equipment, and more particularly to fiber optic assemblies, which may be used to support both live fiber optic connections and tap fiber optic connections for monitoring the live fiber optic connections in a fiber optic network.

2. Technical Background

Benefits of utilizing optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed for use in delivering voice, video, and data transmissions to subscribers over both private and public networks. These fiber optic networks often include separated connection points linking optical fibers to provide “live fiber” from one connection point to another. In this regard, fiber optic equipment is located in data distribution centers or central offices to support live fiber interconnections. For example, the fiber optic equipment can support interconnections between servers, storage area networks (SANs), and/or other equipment at data centers. Interconnections may be further supported by fiber optic patch panels or modules.

Fiber optic equipment can be customized based on application and connection bandwidth needs. The fiber optic equipment is typically included in housings that are mounted in equipment racks to optimize use of space. Many data center operators or network providers also wish to monitor traffic in their networks. Typical users for monitoring technology may be in highly regulated industries like financial, healthcare or other industries that wish to monitor data traffic for archival records, security purposes, and the like. Monitoring devices typically monitor data traffic for security threats, performance issues and transmission optimization, for example. Thus, monitoring devices allow analysis of network traffic and can use different architectures, including an active architecture such as SPAN (i.e., mirroring) ports, or passive architectures, such as port taps. Passive taps in particular have the advantage of not altering the time relationships of frames, grooming data, or filtering out physical layer packets with errors, and are not dependent on network load.

No admission is made that any reference cited herein constitutes prior art. Applicant expressly reserves the right to challenge the accuracy and pertinence of any cited documents.

### SUMMARY

Embodiments disclosed herein include fiber optic assemblies for supporting optical connections in a fiber optic network employing parallel optical configurations. In one embodiment, a fiber optic assembly comprises at least two live multi-fiber components and at least one tap multi-fiber component. The live and tap multi-fiber components each share a parallel optical configuration having a plurality of fiber optic fiber positions for optically connecting optical fibers to the respective components in a predetermined connection location on or in the component. In embodiments disclosed herein, optical signals are routed from a live multi-fiber component to another live multi-fiber component in a parallel optical connection configuration, with each group of optical signals corresponding to a respective group of fiber positions on each live multi-fiber component. Each group of optical signals is also routed to one of the first and second groups of fiber positions of the at least one tap multi-fiber component in a parallel optical connection configuration. In this manner, the fiber optic assembly can support simultaneous transmission and monitoring of fiber optic signals within an active fiber optic network using this parallel optical configuration, without the need for interrupting network operations. This arrangement also allows for greater compatibility with existing networks, because live and tap connections are able to employ the same parallel optical cabling and connection component and are also able to pass signals to both live and tap multi-fiber components using the same types of components and fiber position configurations.

One embodiment of the disclosure relates to a fiber optic assembly for supporting optical connections in a fiber optic network. The fiber optic assembly comprises a first live multi-fiber component having a first plurality of live input fiber positions. The fiber optic assembly further comprises a second live multi-fiber component having a second plurality of live output fiber positions optically connected to the first plurality of live input fiber positions. The fiber optic assembly further comprises at least one tap multi-fiber component having a first plurality of tap input fiber positions optically connected to the second plurality of live output fiber positions having a parallel optical connection configuration therebetween.

An additional embodiment of the disclosure relates to a method of routing live and tap optical signals in a parallel optical configuration. The method comprises receiving a first plurality of live optical input signals at a first plurality of live output fiber positions of a first live multi-fiber component of a fiber optic assembly in a parallel optical connection configuration. The method further comprises splitting the first plurality of live optical input signals into a first plurality of live optical output signals and a first plurality of tap optical output signals. The method further comprises providing the first plurality of live optical output signals to a second plurality of live input fiber positions of a second live optical component of the fiber optic assembly in a parallel optical connection configuration. The method further comprises providing the first plurality of tap optical output signals to a first plurality of tap input fiber positions of at least one tap optical component of the fiber optic assembly in a parallel optical connection configuration.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic view of a conventional Base-8 fiber optic assembly;

FIG. 2A is a schematic view of a Base-8, Type-A fiber optic assembly having two tap multi-fiber connectors according to an exemplary embodiment;

FIG. 2B is a top view of the interior of a Base-8, Type-A fiber optic module employing the Type-A fiber optic assembly in FIG. 2A, wherein the fiber optic module has two tap multi-fiber connectors connected to two tap multi-fiber adapters according to an exemplary embodiment;

FIG. 3 is a schematic view of a Base-8, Type-B fiber optic assembly having two tap multi-fiber connectors according to an exemplary embodiment;

FIG. 4 is a schematic view of a Base-8, Type-A fiber optic assembly having one tap multi-fiber connector according to an exemplary embodiment;

FIG. 5 is a schematic view of a Base-8, Type-B fiber optic assembly having one tap multi-fiber connector according to an exemplary embodiment;

FIG. 6 is a schematic view of a Base-8 to Base-12 tap conversion assembly for converting between three Base-8 connections and two Base-12 connections, with two Base-12 tap multi-fiber connectors for monitoring live traffic through the tap conversion assembly;

FIG. 7 is a schematic view of a portion of a fiber optic network employing the Base-8, Type-A fiber optic assembly of FIG. 2A;

FIG. 8 is a schematic view of a portion of a fiber optic network employing the Base-8, Type-B fiber optic assembly of FIG. 3;

FIG. 9 is a schematic view of a portion of a fiber optic network employing the Base-8, Type-A fiber optic assembly of FIG. 4;

FIG. 10 is a schematic view of a portion of a fiber optic network employing the Base-8, Type-B fiber optic assembly of FIG. 5;

FIGS. 11A and 11B are schematic views of a portion of a fiber optic network employing the Base-8 to Base-12 tap conversion assembly of FIG. 6; and

FIG. 12 is a flow chart illustrating a method of routing optical signals in a fiber optic assembly using parallel optics according to an exemplary embodiment.

### DETAILED DESCRIPTION

Embodiments disclosed herein include fiber optic assemblies for supporting optical connections in a fiber optic network employing parallel optical configurations. In one embodiment, a fiber optic assembly comprises at least two live multi-fiber components and at least one tap multi-fiber component. The live and tap multi-fiber components each share a parallel optical configuration having a plurality of fiber optic fiber positions for optically connecting optical fibers to the respective components in a predetermined connection location on or in the component. In embodiments disclosed herein, optical signals are routed from a live multi-fiber component to another live multi-fiber component in a parallel optical connection configuration, with each group of optical signals corresponding to a respective group of fiber positions on each live multi-fiber component. Each group of optical signals is also routed to one of the first and second groups of fiber positions of the at least one tap multi-fiber component in a parallel optical connection configuration. In this manner, the fiber optic assembly can support simultaneous transmission and monitoring of fiber optic signals within an active fiber optic network using this parallel optical configuration, without the need for interrupting network operations. This arrangement also allows for greater compatibility with existing networks, because live and tap connections are able to employ the same parallel optical cabling and connection component and are also able to pass signals to both live and tap multi-fiber components using the same types of components and fiber position configurations.

Various embodiments will be further clarified by the following examples. Before discussing the embodiments disclosed herein, a fiber optic assembly employing parallel optics that does not include a tap multi-fiber adapter is first described. Parallel optics divide high amounts of upstream and downstream data bandwidth across multiple upstream and downstream optical fibers. By dedicating multiple fibers each to output optical signals and receive optical signals, each parallel optical configuration can transfer a multiple of the maximum bandwidth of each individual optical fiber in each direction.

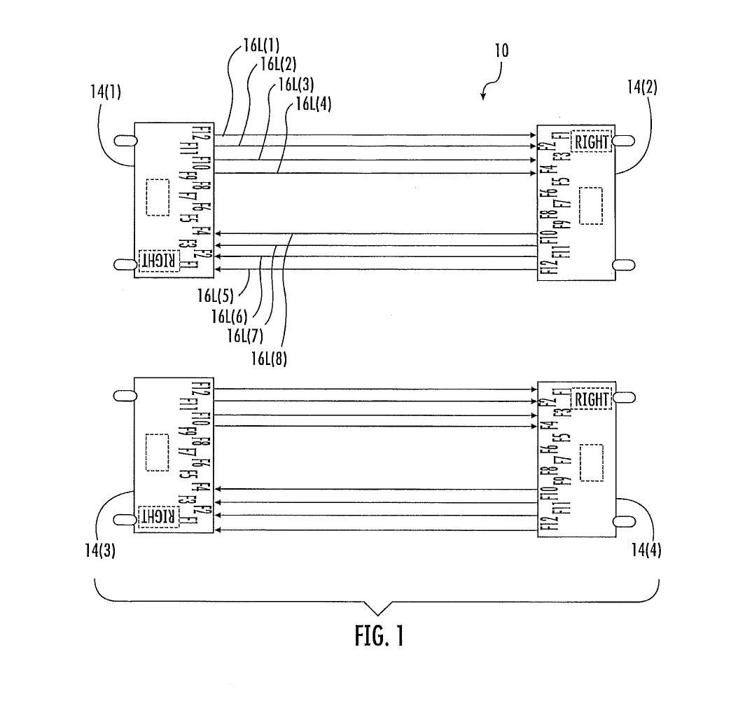

In this regard, FIG. 1 illustrates a fiber optic assembly 10 employing a live parallel optical configuration. The fiber optic assembly 10 is illustrated in FIG. 1 as supporting four live multi-fiber connectors 14(1)-14(4). In this embodiment, each live multi-fiber connector 14(1)-14(4) is a multi-fiber connector having twelve (12) connection positions, also referred to herein as fiber positions, configured to support up to twelve (12) optical fibers. As used herein, fiber positions are fiber connection positions in a fiber optic connector or other multi-fiber fiber optic connection component that pre-determine the connection location of fibers to the component. When using a twelve (12) connection multi-fiber connector, such as an MPO or MTP type connector for example, a base-8 parallel optical solution includes eight (8) live optical fibers 16L, which use only eight (8) of the twelve (12) fiber positions of each live multi-fiber connector 14. The multi-fiber connectors 14(1)-14(4) may be configured to be optically connected to multi-fiber adapters (not shown) included in a fiber optic assembly according to the fiber optic assembly 10, or may comprise other types of fiber optic connection components.

With continuing reference to FIG. 1, a number of different polarity schemes can be employed in the fiber optic assembly 10. In this application, for example, a “Type-A” parallel optical polarity scheme refers to a polarity arrangement in which each live optical connection is connected between the same fiber positions of two live fiber optic positions. A “Type-B” parallel optical polarity scheme, on the other hand, refers to a polarity arrangement in which each live optical connection is connected between opposite fiber positions of two live fiber optic connectors. In the embodiment of FIG. 1, for example, a Type-B polarity arrangement is shown in the fiber optic assembly 10, meaning that live optical fiber 16L(1) is connected between fiber position F12 of live multi-fiber connector 14(1) and fiber position F1 of live multi-fiber connector 14(2), live optical fiber 16L(2) is connected between fiber position F11 of live multi-fiber connector 14(1) and fiber position F2 of live multi-fiber connector 14(2), and so on. It should be understood that in this and other examples, fiber positions F1-F12 may also be referred to as fiber positions 1-12 for convenience.

The configuration of the fiber optic assembly 10 of FIG. 1 is an example of a “Base-8” standard configuration that employs four (4) upstream and four (4) downstream optical fibers, each having 10 Gigabits per second (10 G) of bandwidth, for a total of 40 G in each direction. As network speeds increase to support 25 G per optical fiber and beyond, a corresponding Base-8 system can be scaled up to support 100 G of bandwidth and beyond as an example. Accordingly, there is a need to integrate solutions into parallel optical systems in a way that does not interrupt active network activity.

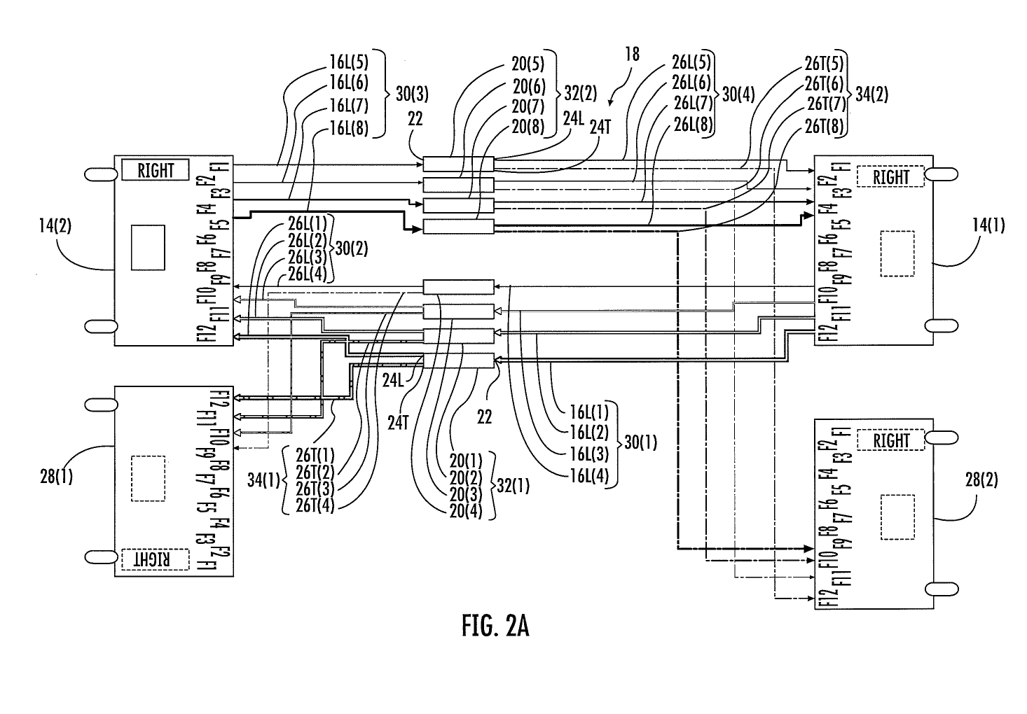

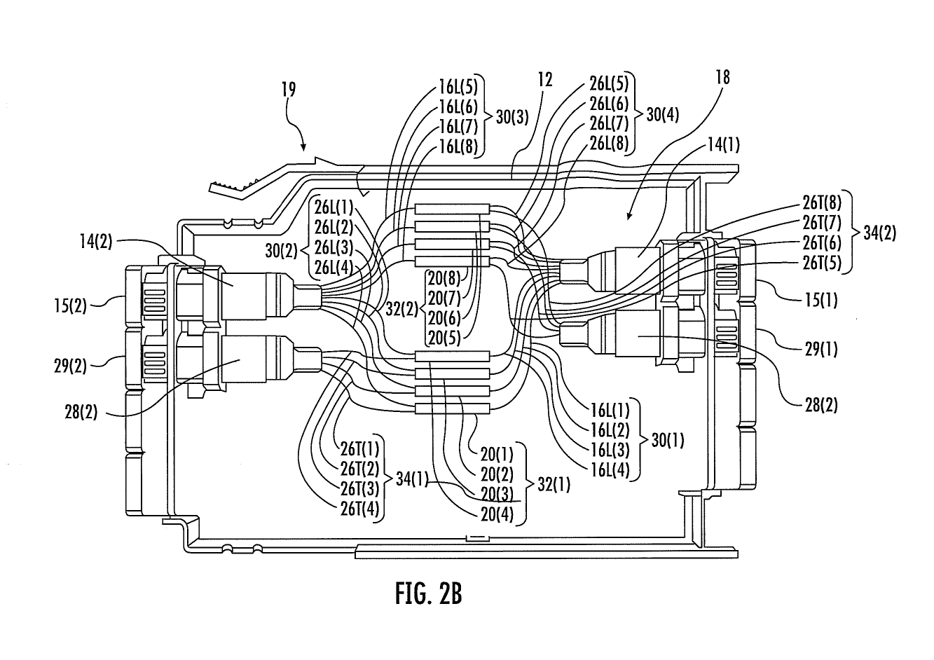

In this regard, FIG. 2A illustrates a fiber optic assembly 18, also referred to herein as “assembly 18.” As will be discussed in greater detail below, the fiber optic assembly 18 in FIG. 2A has a Base-8 parallel optical configuration and a Type-A polarity configuration. In this regard, the fiber optic assembly 18 in this example in FIG. 2A provides certain fiber positions and fiber splitting to facilitate optical connections with multi-fiber connectors. For example, a first live multi-fiber connector 14(1) and a second live multi-fiber connector 14(2) are shown connected to the fiber optic assembly 18. In this regard, four (4) live optical fibers 16L(1)-16L(4) are optically connected between fiber positions F9-F12 of the first live multi-fiber connector 14(1) and four optical splitters 20(1)-20(4). The optical splitters 20(1)-20(4) each split the optical signal received at a live input 22 from the respective live optical fibers 16L(1)-16L(4). Each optical splitter 20 then outputs the signal to a respective live output 24L connected to a live optical fiber 26L and a respective tap output 24T connected to a tap optical fiber 26T.

Live optical fibers 26L(1)-26L(4) are connected between optical splitters 20(1)-20(4) and fiber positions F9-F12 of the second live multi-fiber connector 14(2). At the same time, a corresponding set of live optical fibers 16L(5)-16L(8) are connected between fiber positions F1-F4 of the second live multi-fiber connector 14(2) and optical splitters 20(5)-20(8), and a corresponding set of live optical fibers 26L(5)-26L(8) are connected between optical splitters 20(5)-20(8) and fiber positions F1-F4 of the first live multi-fiber connector 14(1).

In this manner, live optical connections are maintained between live multi-fiber connectors 14(1) and 14(2). Because each optical splitter 20 redirects a portion of the signal received at live input 22 to tap output 24T, however, it is now also possible to monitor traffic in both directions between live multi-fiber connectors 14(1) and 14(2). Here, tap optical fibers 26T(1)-26T(4) are connected between optical splitters 20(1)-20(4) and fiber positions F9-F12 of a first tap multi-fiber connector 28(1), thereby permitting monitoring of traffic communicated through the live multi-fiber connector 14(1) and received by adjacent live multi-fiber connector 14(2). Likewise, tap optical fibers 26T(5)-26T(8) are connected between optical splitters 20(5)-20(8) and fiber positions F9-F12 of a second tap multi-fiber connector 28(2), thereby permitting monitoring of traffic communicated through the live multi-fiber connector 14(2) and received by adjacent live multi-fiber connector 14(1). It should be noted that, in this embodiment, each tap multi-fiber connector 28 is configured to receive the same signals as its corresponding adjacent live multi-fiber connector 14, thereby permitting a user to easily determine visually which live signals correspond to each tap multi-fiber connector 28. It should also be noted that, in this and other embodiments, alternative fiber optic connection components having fiber connection positions may be substituted for the live multi-fiber connectors 14(1) and 14(2) and/or tap multi-fiber connectors 28(1) and 28(2).

As discussed above, the assembly 18 of FIG. 2A has a Base-8 parallel optical configuration. As used herein, Base-8 refers to a parallel optical configuration for a twelve-connection multi-fiber connector, such as an MPO, MPT or other connector, in which the outermost groups of four (4) fiber positions are used, i.e., fiber positions F1-F4 and F9-F12, with one group used for receiving optical signals and the other group used for providing transmitted optical signals. For example, without being limiting, by dedicating four (4) fibers each to pass transmitted optical signals and receive optical signals, each Base-8 configuration can transfer up to forty gigabits-per-second (40 G) in both directions using a current 10 G/fiber standard, and can transfer up to 100 G in both directions using a more advanced 25 G/fiber standard, and so on.

In addition, as also discussed above, the assembly 18 of FIG. 2A has a Type-A polarity configuration. As used herein, Type-A refers to a configuration of N fiber optic connections in which one half of the fiber positions (e.g., fiber positions 1 through (N/2)) of a first live multi-fiber connector are optically connected to a corresponding first half of the fiber positions (e.g., fiber positions 1 through (N/2)) of a second live multi-fiber connector, and fiber positions (N/2+1) through N of the first live multi-fiber connector are optically connected to corresponding fiber positions (N/2+1) through N of the second live multi-fiber connector. Said another way, in a Type-A configuration, one half of the fiber positions carries live signals in a consistent direction (e.g., downlink or uplink), and the other half of the fiber positions carries live signals in the opposite direction. This arrangement thus allows for greater compatibility with existing networks, because live and tap connections are able to employ the same parallel optical cabling and connectors and are also able to pass signals to both live and tap multi-fiber connectors using the same types of connectors and fiber positions.

In the example of FIG. 2A, the Base-8 configuration is an 8-connection subset of a larger 12-connection parallel optical configuration. Thus, in this Base-8 example, N=8 for eight (8) active fiber positions, with fiber positions F1-F4 (i.e., 1 through (N/2)) corresponding to fiber positions F1-F4 of the 12-connection parallel optical configuration, and fiber positions F5-F8 of the Base-8 configuration (i.e., (N/2+1) through 8) corresponding to fiber positions F9-F12 of the 12-connection parallel optical configuration.

Thus, in the example of FIG. 2A, it can be seen that a first group of live optical fibers 30(1) (i.e., live optical fibers 16L(1)-16L(4)) are connected between a second group of fiber positions of the Base-8 parallel optical configuration (i.e., fiber positions F9-F12) of both live multi-fiber connectors 14(1) and 14(2) via a first group of optical splitters 32(1) (i.e., optical splitters 20(1)-20(4)). Similarly, a third group of live optical fibers 30(3) (i.e., live optical fibers 16L(5)-16L(8)) are connected between a first group of fiber positions of the Base-8 parallel optical configuration (i.e., fiber positions F1-F4) of both live multi-fiber connectors 14(1) and 14(2) via a second group of optical splitters 32(2) (i.e., optical splitters 20(5)-20(8)). Accordingly, for subsequent embodiments, groups of components such as groups of live optical fibers 30(1)-30(4) and groups of optical splitters 32(1)-32(2) will be referred to as such where appropriate. Likewise, for subsequent embodiments, identification of individual components, such as live optical fibers 16L(1)-16L(8), live optical fibers 26L(1)-26L(8), etc., will be omitted when referred to in the above identified groups.

In this embodiment, a first group of tap optical fibers 34(1) (i.e., tap optical fibers 26T(1)-26T(4)) is connected between the first group of optical splitters 32(1) and the second group of fiber positions (i.e., fiber positions F9-F12) of the tap multi-fiber connector 28(1), and a second group of tap optical fibers 34(2) (i.e., tap optical fibers 26T(5)-26T(8)) is connected between the second group of optical splitters 32(2) and the second group of fiber positions (i.e., fiber positions F9-F12) of the tap multi-fiber connector 28(2). Thus, it can be seen that the above described assembly 18 permits simultaneous monitoring of upstream and downstream traffic over live multi-fiber connectors 14(1) and 14(2) via the pair of tap multi-fiber connectors 28(1) and 28(2) connected to the assembly 18.

The fiber optic assembly 18 in FIG. 2A can be employed in a fiber optic module, if desired. In this regard, FIG. 2B is a schematic view of a Base-8, Type-A fiber optic module 19 employing the Type-A fiber optic assembly 18 in FIG. 2A. The fiber optic module 19 includes an enclosure 12 that houses the optical fibers 30(1)-30(4) and 34(1)-34(2), and the optical splitters 32(1)-32(2) to provide the Type-A polarity configuration. A first live multi-fiber adapter 15(1) is disposed on a rear side of the enclosure 12. A second live multi-fiber adapter 15(2) is disposed on a front side of the enclosure 12. The first and second live multi-fiber adapters 15(1), 15(2) receive the first and second live multi-fiber connectors 14(1)-14(2) of assembly 18. The first and second live multi-fiber adapters 15(1), 15(2) allow other live fiber optic connectors of fiber optic cables external to the fiber optic module 19 to be optically connected to the first and second live multi-fiber connectors 14(1)-14(2) to carry live optical signals and establish optical connections with the live optical fibers 30(1)-30(4) connected to the first and second live multi-fiber connectors 14(1), 14(2), as discussed in FIG. 2A above. A first tap multi-fiber adapter 29(1) is disposed on a rear side of the enclosure 12. A second tap multi-fiber adapter 29(2) disposed on a front side of the enclosure 12. The first and second tap multi-fiber adapters 29(1), 29(2) facilitate receiving the first and second tap multi-fiber connectors 28(1), 28(2). The first and second tap multi-fiber adapters 29(1), 29(2) allow other tap fiber optic connectors of fiber optic cables external to the fiber optic module 19 to be optically connected to the first and second tap multi-fiber connectors 28(1), 28(2) to receive the tapped optical connections from the optical splitters 32(1), 32(2) via the tap optical fibers 34(1)-34(2), as discussed in FIG. 2A above.

Another polarity configuration is referred to herein as a Type-B polarity configuration. As used herein, Type-B refers to a configuration of N fiber optic connections in which one half of the fiber positions (e.g., fiber positions 1 through (N/2)) of a first live multi-fiber connector are optically connected to a corresponding second half of the fiber positions (e.g., fiber positions (N/2)+1 through N) of a second live multi-fiber connector, and the second half of the fiber positions (e.g., fiber positions (N/2)+1 through N) of the first live multi-fiber connector are optically connected to corresponding first half of the fiber positions (e.g., fiber positions 1 through (N/2)) of the second live multi-fiber connector. Said another way, in a Type-B configuration, a first half of the fiber positions of each live multi-fiber connector is always configured to carry live signals to the second half of the fiber positions of the opposite live multi-fiber connector, and the second half of the fiber positions of each live multi-fiber connector is likewise always configured to receive live signals from the first half of the fiber positions of the opposite live multi-fiber connector.

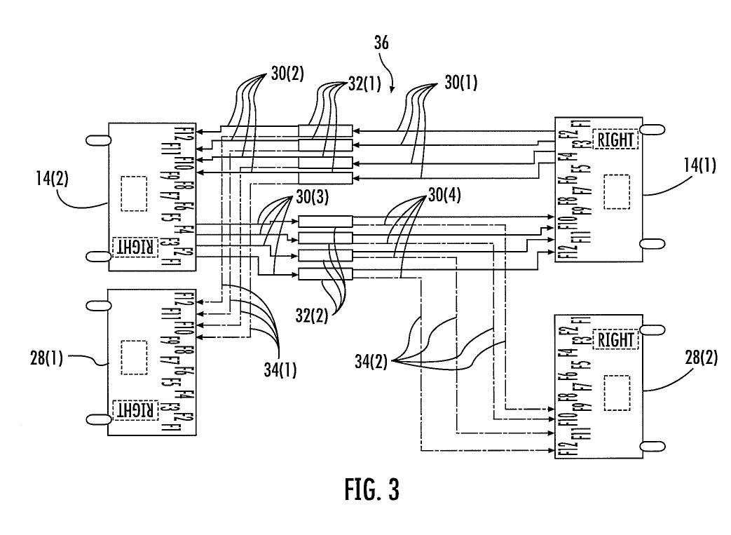

In this regard, FIG. 3 illustrates a fiber optic assembly 36, also referred to as “assembly 30,” having a Type-B polarity configuration according to another embodiment. Similar to the assembly 18 of FIG. 2A above, the assembly 36 includes the first live multi-fiber connector 14(1) and the second tap multi-fiber connector 28(2). In this embodiment, the second live multi-fiber connector 14(2) and first tap multi-fiber connector 28(1) are also provided. The assembly 36 can also be disposed in a fiber optic module, for example, in a manner similar to the embodiment of FIG. 2B, if desired.

Instead of the Type-A polarity configuration provided in the assembly 18 in FIG. 2A, however, the assembly 36 in FIG. 3 has a Type-B polarity configuration, with a first group of live optical fibers 30(1) connected between the live inputs 22 (not shown) of a first group of optical splitters 32(1) and a first group of fiber positions (i.e., fiber positions F1-F4) of the first live multi-fiber connector 14(1). A second group of live optical fibers 30(2) is connected between the live outputs 24L (not shown) of the first group of optical splitters 32(2) and the second group of fiber positions (fiber positions F9-F12) of the second live multi-fiber connector 14(2). Similarly, a third group of live optical fibers 30(3) is connected between the live inputs 22 (not shown) of the second group of optical splitters 32(2) and the first group of fiber positions (fiber positions F1-F4) of the second live multi-fiber connector 14(2). A fourth group of live optical fibers 30(4) is connected between the live outputs 24L (not shown) of the second group of optical splitters 32(2) and the second group of fiber positions (fiber positions F9-F12) of the first live multi-fiber connector 14(1).

Similar to the assembly 18 of FIG. 2A, the first group of tap optical fibers 34(1) is connected between the tap outputs 24T (not shown) of the first group of optical splitters 32(1) and the second group of fiber positions (fiber positions F9-F12) of the first tap multi-fiber connector 28(1). Likewise, a second group of tap optical fibers 34(2) is connected between the tap outputs 24T (now shown) of the second group of optical splitters 32(2) and the second group of fiber positions (fiber positions F9-F12) of the second tap multi-fiber connector 28(2).

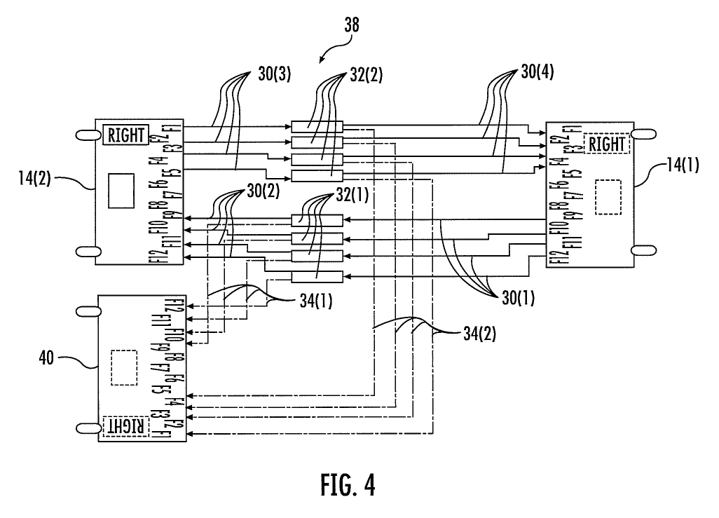

Thus, it can be seen that a two-tap multi-fiber solution is applicable to both a Type-A and Type-B assembly, such as Type-A assembly 18 or Type-B assembly 36. It should also be understood that a different number of tap multi-fiber connectors could be used, for example to consolidate all tap outputs into a single multi-fiber connector. In this regard, FIG. 4 illustrates a fiber optic assembly 38 with live multi-fiber connectors 14(1) and 14(2) interconnected in a Type-A polarity configuration similar to the assembly 18 of FIG. 2A, and having one tap multi-fiber connector 40 that is configured to receive both groups of live signals provided by the live multi-fiber connectors 14(1) and 14(2).

As discussed above with respect to FIG. 2A, the first group of live optical fibers 30(1) is connected between the first group of optical splitters 32(1) and the second group of fiber positions (fiber positions F9-F12) of the first live multi-fiber connector 14(1), and the second group of live optical fibers 30(2) is connected between the first group of optical splitters 32(1) and the second group of fiber positions (fiber positions F9-F12) of the second live multi-fiber connector 14(2). Likewise, the third group of live optical fibers 30(3) is connected between the second group of optical splitters 32(2) and the first group of fiber positions (fiber positions F1-F4) of the second live multi-fiber connector 14(2), and the fourth group of live optical fibers 30(4) is connected between the second group of optical splitters 32(2) and the first group of fiber positions (fiber positions F1-F4) of the first live multi-fiber connector 14(1).

In this embodiment, however, the first group of tap optical fibers 34(1) is connected between the first group of optical splitters 32(1) and the second group of fiber positions (fiber positions F9-F12) of the tap multi-fiber connector 40, and the second group of tap optical fibers 34(2) is connected between the second group of optical splitters 32(2) and the first group of fiber positions (fiber positions F1-F4) of the same tap multi-fiber connector 40. This embodiment thereby permits monitoring of all eight live connections via a single tap multi-fiber connector 40 having the same Base-8 parallel optical configuration as the live multi-fiber connectors 14(1) and 14(2).

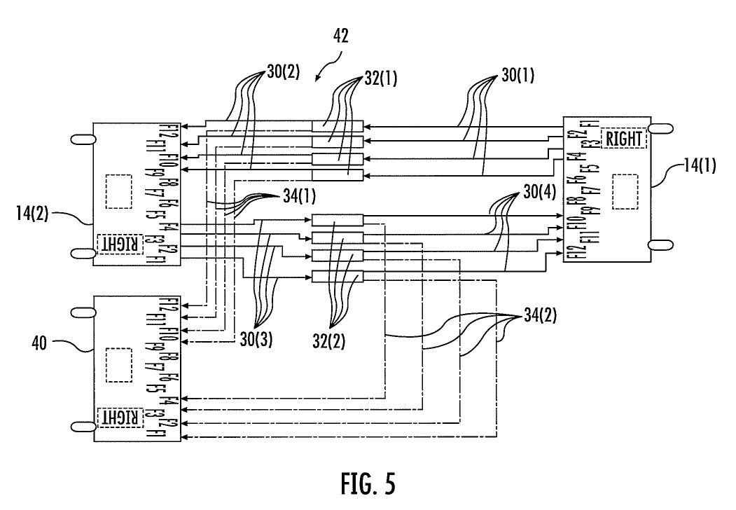

This one-tap multi-fiber parallel optical configuration is compatible with a Type-B polarity configuration as well. In this regard, FIG. 5 illustrates an assembly 42 with live multi-fiber connectors 14(1) and 14(2) interconnected in a Type-B polarity configuration similar to the assembly 36 of FIG. 3, and having one tap multi-fiber connector 40 that is configured to receive both groups of live signals provided by the live multi-fiber connectors 14(1) and 14(2).

As discussed above with respect to FIG. 3, the first group of live optical fibers 30(1) is connected between the first group of optical splitters 32(1) and the first group of fiber positions (fiber positions F1-F4) of the first live multi-fiber connector 14(1), and the second group of live optical fibers 30(2) is connected between the first group of optical splitters 32(1) and the second group of fiber positions (fiber positions F9-F12) of the second live multi-fiber connector 14(2). Likewise, the third group of live optical fibers 30(3) is connected between the second group of optical splitters 32(2) and the first group of fiber positions (fiber positions F1-F4) of the second live multi-fiber connector 14(2), and the fourth group of live optical fibers 30(4) is connected between the second group of optical splitters 32(2) and the second group of fiber positions (fiber positions F9-F12) of the first live multi-fiber connector 14(1).

As with the Type-A assembly 38 of FIG. 4, the first group of tap optical fibers 34(1) of FIG. 5 is connected between the first group of optical splitters 32(1) and the second group of fiber positions (fiber positions F9-F12) of the tap multi-fiber connector 40, and the second group of tap optical fibers 34(2) is connected between the second group of optical splitters 32(2) and the first group of fiber positions (fiber positions F1-F4) of the same tap multi-fiber connector 40. This embodiment thereby also permits monitoring of all eight live connections via a single tap multi-fiber connector 40 having the same Base-8 parallel optical configuration as the live multi-fiber connectors 14(1) and 14(2).

As discussed above, Base-8 parallel optical configurations are well suited for four channel applications, such as 40 G with 10 G channels, or 100 G with 25 G channels, or other configurations. However, it may also be desirable to maximize bandwidth density by employing all twelve of the fiber positions of multi-fiber connections used in some portions of the network. For example, switching solutions may be required to manage many hundreds or thousands of fiber optic connections in a relatively small amount of rack space. Thus, it may be desirable to be able to convert a plurality of Base-8 parallel optical configurations to a smaller number of Base-12 parallel optical configurations using the same multi-fiber connector types, thereby allowing a larger total number of connections to occupy the same amount of rack space. The additional space may also allow for the addition of Base-12 tap connections that might not otherwise fit into the existing rack space as Base-8 tap connections.

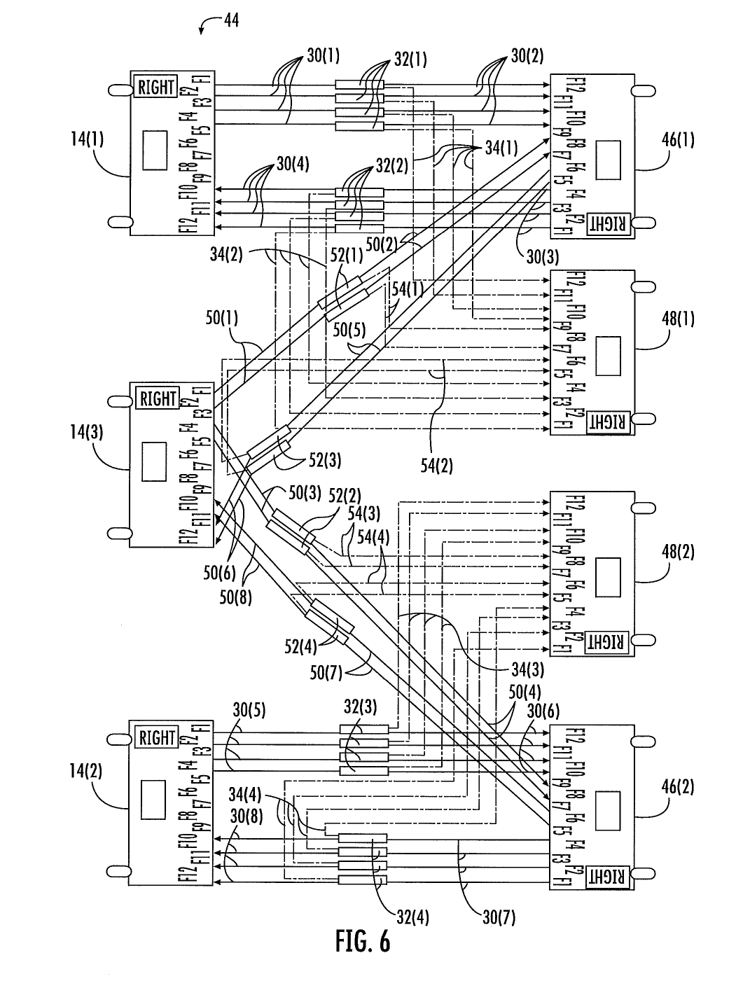

In this regard, FIG. 6 illustrates an exemplary Base-8 to Base-12 tap conversion assembly 44. The tap conversion assembly 44 has three Base-8 live multi-fiber connectors 14(1)-14(3) on the front end of the tap conversion assembly 44, and two Base-12 live multi-fiber connectors 46(1) and 46(2) on the rear end of the tap conversion assembly 44. A pair of Base-12 tap multi-fiber connectors 48(1) and 48(2) is also disposed in the tap conversion assembly 44.

In this embodiment, live multi-fiber connector 14(1) is connected to live multi-fiber connector 46(1) in a Type-B configuration, with fiber positions F1-F4 of live multi-fiber connector 14(1) connected to fiber positions F9-F12 of live multi-fiber connector 46(1) via the first group of live optical fibers 30(1), first group of optical splitters 32(1), and second group of live optical fibers 30(2), and fiber positions F1-F4 of live multi-fiber connector 46(1) connected to fiber positions F9-F12 of live multi-fiber connector 14(1) via the third group of live optical fibers 30(3), second group of optical splitters 32(2), and fourth group of live optical fibers 30(4). Likewise, live multi-fiber connector 14(2) is also connected to live multi-fiber connector 46(2) in a Type-B configuration, with fiber positions F1-F4 of live multi-fiber connector 14(2) connected to fiber positions F9-F12 of live multi-fiber connector 46(2) via the fifth group of live optical fibers 30(5), third group of optical splitters 32(3), and sixth group of live optical fibers 30(6), and fiber positions F1-F4 of live multi-fiber connector 46(2) connected to fiber positions F9-F12 of live multi-fiber connector 14(2) via the seventh group of live optical fibers 30(7), fourth group of optical splitters 32(4), and eighth group of live optical fibers 30(8).

In this embodiment, it can be seen that the eight fiber positions used by the third Base-8 live multi-fiber connector 14(3) can be divided across the remaining fiber positions (fiber positions F5-F8) of the live multi-fiber connectors 46(1) and 46(2), thereby employing all twelve of the fiber positions of live multi-fiber connectors 46(1) and 46(2). In this embodiment, the eight active fiber positions of live multi-fiber connector 14(3) are divided into four pairs, with the outer pairs being routed to live multi-fiber connector 46(1) and the inner pairs being routed to live multi-fiber connector 46(2). Specifically, fiber positions F1 and F2 of live multi-fiber connector 14(3) are interconnected with fiber positions F7 and F8 of live multi-fiber connector 46(1) via a first pair of live optical fibers 50(1), a first pair of optical splitters 52(1), and a second pair of live optical fibers 50(2), and fiber positions F3 and F4 of live multi-fiber connector 14(3) are interconnected with fiber positions F7 and F8 of live multi-fiber connector 46(2) via a third pair of live optical fibers 50(3), second pair of optical splitters 52(2), and a fourth pair of live optical fibers 50(4). Likewise, fiber positions F5 and F6 of live multi-fiber connector 46(1) are interconnected with fiber positions F11 and F12 of live multi-fiber connector 14(3) via a fifth pair of live optical fibers 50(5), a third pair of optical splitters 52(3), and a sixth pair of live optical fibers 50(6), and fiber positions F5 and F6 of live multi-fiber connector 46(2) are interconnected with fiber positions F9 and F10 of live multi-fiber connector 14(3) via a seventh pair of live optical fibers 50(7), fourth pair of optical splitters 52(4), and an eighth pair of live optical fibers 50(8).

In this manner, a tap conversion assembly 44 can be configured to convert twenty-four (24) total live connections between three Base-8 live multi-fiber connectors 14(1)-14(3) and two Base-12 live multi-fiber connectors 46(1) and 46(2). As can be seen in FIG. 6, a similar Base-8 to Base-12 conversion can be used to provide all twenty four (24) live optical connections to a pair of Base-12 tap multi-fiber connectors 48(1) and 48(2). Specifically, fiber positions F9-F12 of tap multi-fiber connector 48(1) are connected to the first group of tap optical fibers 34(1) and fiber positions F1-F4 of tap multi-fiber connector 48(1) are connected to the second group of tap optical fibers 34(2), thereby tapping all live signals associated with live multi-fiber connector 14(1). Similarly, fiber positions F9-F12 of tap multi-fiber connector 48(2) are connected to the third group of tap optical fibers 34(3) and fiber positions F1-F4 of tap multi-fiber connector 48(2) are connected to the fourth group of tap optical fibers 34(4), thereby tapping all live signals associated with live multi-fiber connector 14(2).

The eight live signals associated with live multi-fiber connector 14(3) are tapped by both tap multi-fiber connectors 48(1) and 48(2), using the remaining fiber positions F5-F8 of both tap multi-fiber connectors 48(1) and 48(2). Specifically, fiber positions F7 and F8 of tap multi-fiber connector 48(1) are connected to the first pair of tap fibers 54(1) and fiber positions F5 and F6 of tap multi-fiber connector 48(1) are connected to the second pair of tap fibers 54(2). Likewise, fiber positions F7 and F8 of tap multi-fiber connector 48(2) are connected to the third pair of tap fibers 54(3) and fiber positions F5 and F6 of tap multi-fiber connector 48(2) are connected to the fourth pair of tap fibers 54(4). Thus, it can be seen that tap conversion assembly 44 allows high-density transmission of both live and tap optical signals.

It should be understood that other parallel optical configurations are possible as well. In one non-limiting example, another standard parallel optical configuration may use a 24-connection multi-fiber connector (not shown), and employ ten active fiber connections in each direction. In this example, fiber positions F2-F11 of the multi-fiber connector may be used for one direction and fiber positions F14-F23 could be used in the other direction. Thus, it can be seen that, using the tap multi-fiber connector assemblies and conversion assemblies, such as the embodiments described above, can allow for a variety of different fiber optic network configurations that enable simultaneous tap multi-fiber connector monitoring without interrupting live traffic.

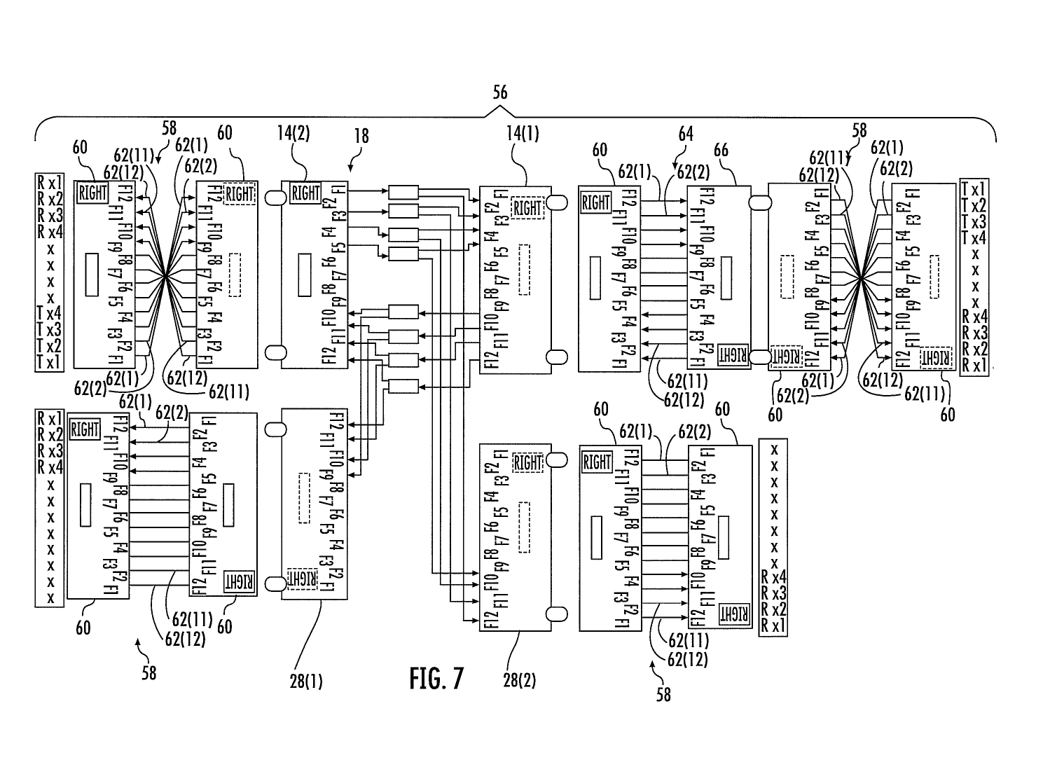

In this regard, FIG. 7 illustrates a portion of a fiber optic network 56 employing the Type-A assembly 18, described in detail above with respect to FIG. 2A. In this example, a Type-B jumper cable 58 is attached to live multi-fiber connector 14(2) and to each of the tap multi-fiber connectors 28(1) and 28(2), thereby enabling the connection of additional fiber optic components, devices or other equipment (not shown). Because of the Type-B polarity configuration of jumper cable 58, each fiber position of a given multi-fiber connector 60 is optically connected to the opposite fiber position of the opposite multi-fiber connector 60. For example, optical fiber 62(1) is connected between fiber positions F1 and F12 of opposite multi-fiber connectors 60, optical fiber 62(2) is connected between fiber positions F2 and F11 of opposite multi-fiber connectors 60, and so on.

Type-B trunk cable 64 is connected to live multi-fiber connector 14(1) and is configured with the same Type-B polarity arrangement between a multi-fiber connector 60 on one end and a multi-fiber connector 66 on the other. Another Type-B jumper cable 58 is connected to the multi-fiber connector 66 of the trunk cable 64, for example to enable connection of a fiber optic component (not shown) at a greater distance from the assembly 18.

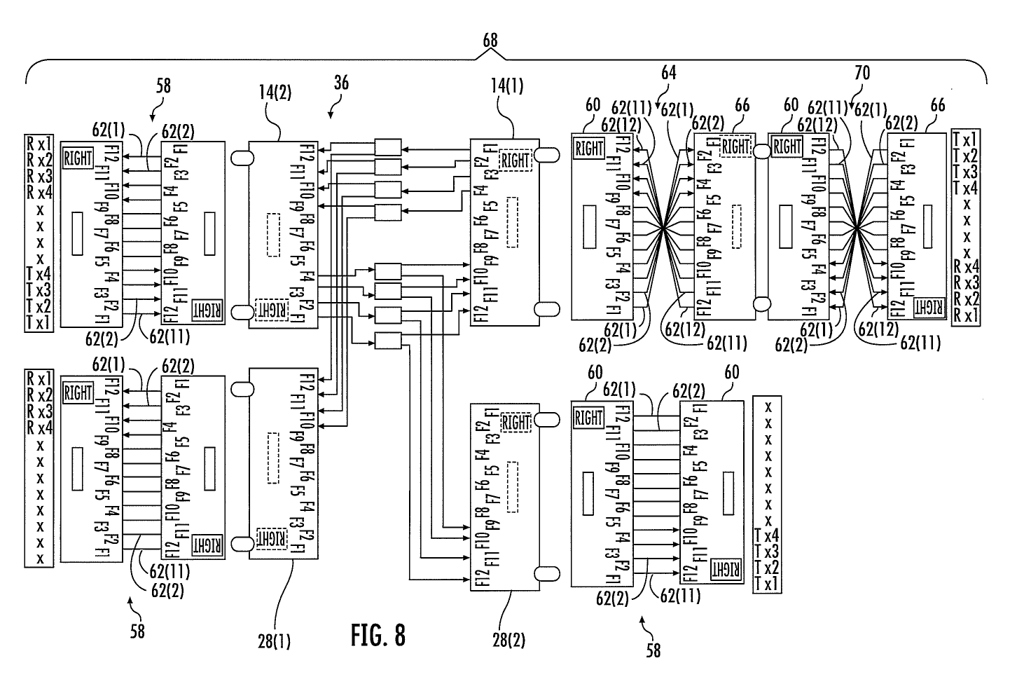

Additional networks employing the different assemblies and conversion assemblies described herein will now be described. In this regard, FIG. 8 illustrates a portion of a fiber optic network 68 having the Type-B assembly 36 of FIG. 3. Each of the live multi-fiber connector 14(2) and first and second tap multi-fiber connectors 28(1) and 28(2) are connected to a respective Type-B jumper cable 58, and the live multi-fiber connector 14(1) is connected to a Type-B trunk cable 64. In this embodiment, a Type-A jumper cable 70 is required to correct the polarity of the live signals corresponding to live multi-fiber connector 14(1).

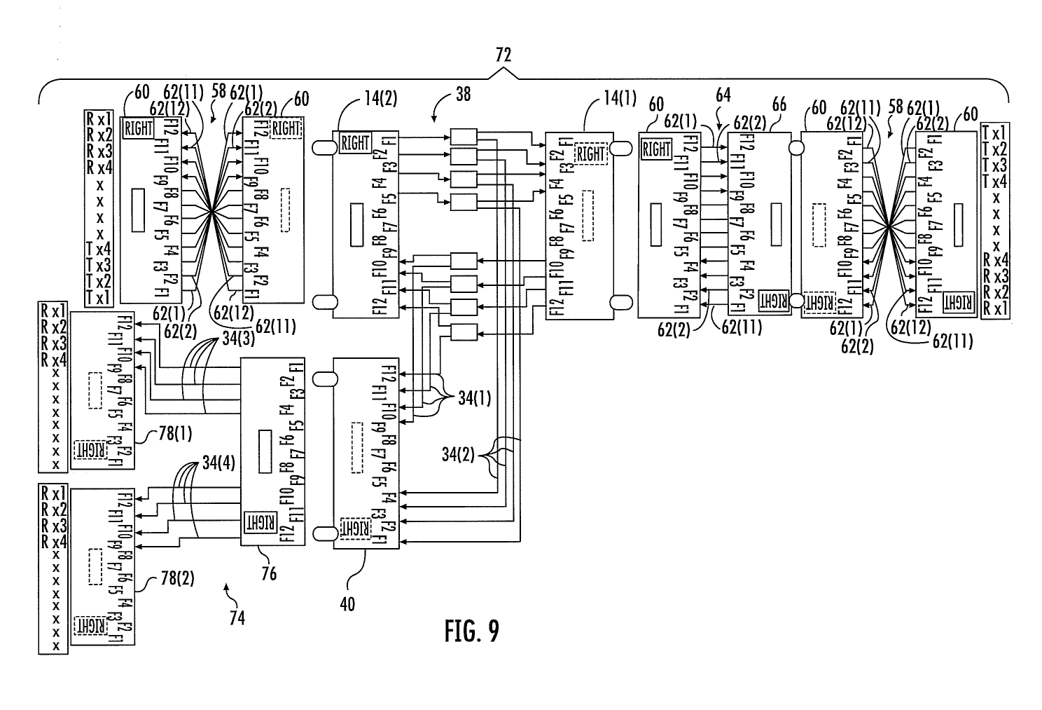

FIG. 9 illustrates a portion of a network 72 employing a Type-A assembly 38 as described in FIG. 4. In this embodiment, jumper cables 58 and trunk cable 64 are connected to the live multi-fiber connectors 14(1) and 14(2) in a manner similar to the fiber optic network 56 of FIG. 7. However, because only one combined tap multi-fiber connector 40 is used, a Y-optical fiber cable assembly 74 is used to separate the tap signals from the tap multi-fiber connector 40 and provide the respective groups of tap signals to different components (not shown). The Y-optical fiber cable assembly 74 includes a connector 76 that routes two groups of tap optical fibers 34(3) and 34(4) to fiber positions F9-F12 of corresponding tap connectors 78(1) and 78(2). In this manner, a single tap multi-fiber connector 40 can be used in the assembly 38 while still permitting monitoring of different groups of tap signals by different devices.

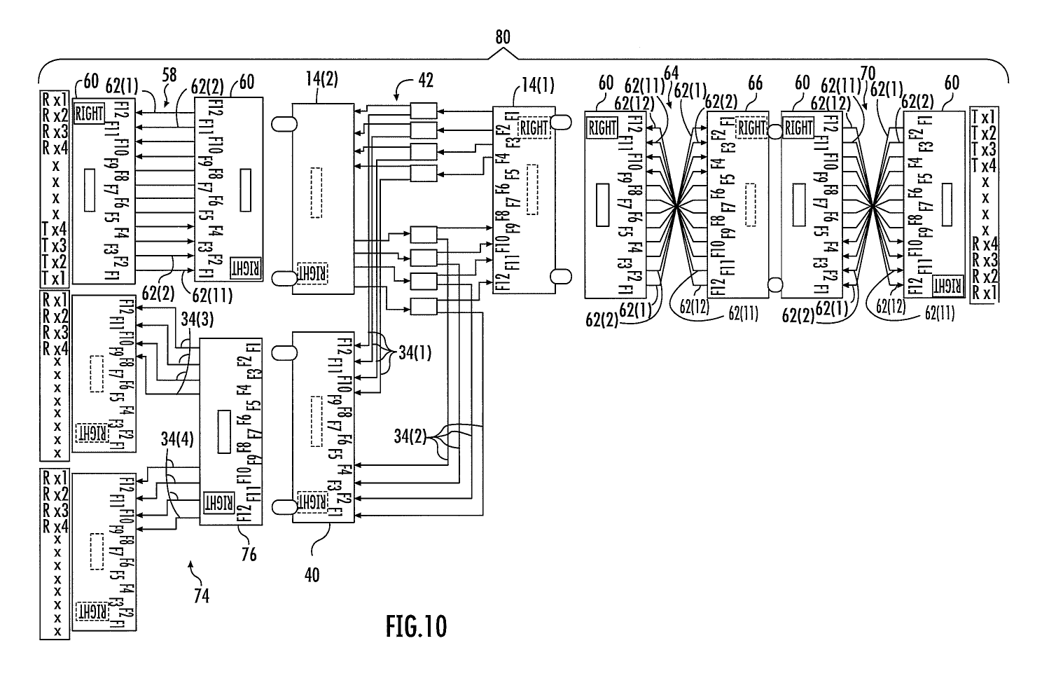

FIG. 10 discloses a portion of a similar network 80 employing a Type-B assembly 42 as described in FIG. 5. The jumper cables 58, 70 and trunk cable 64 are connected to the live multi-fiber connectors 14(1) and 14(2) in a manner similar to the network 68 of FIG. 8, while the Y-optical fiber cable assembly 74 is arranged in a manner similar to the network 72 of FIG. 9.

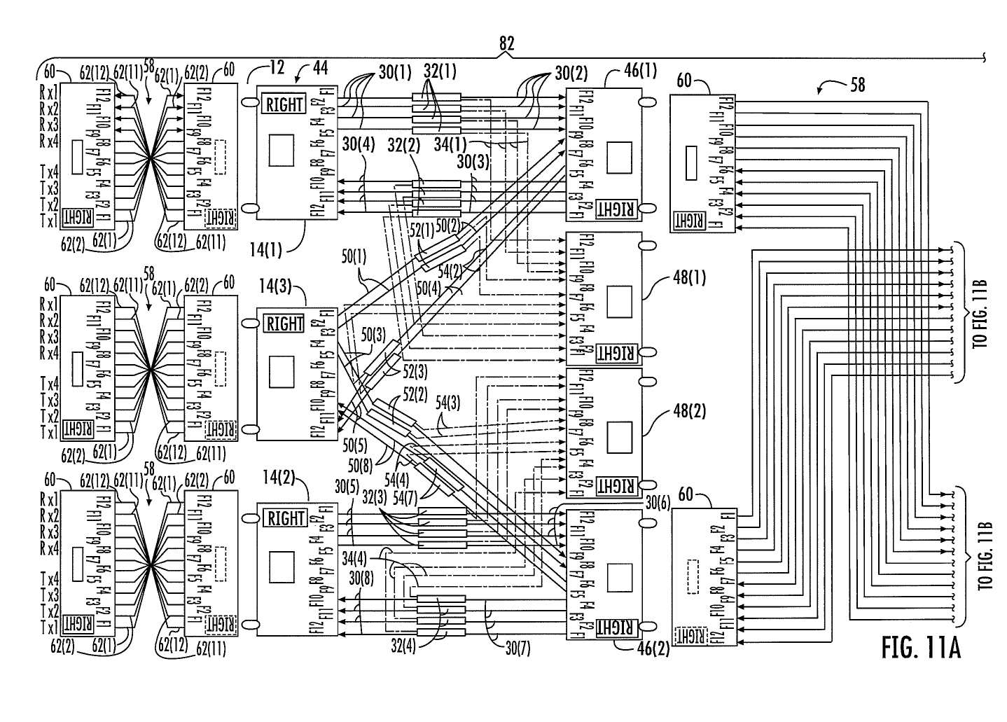

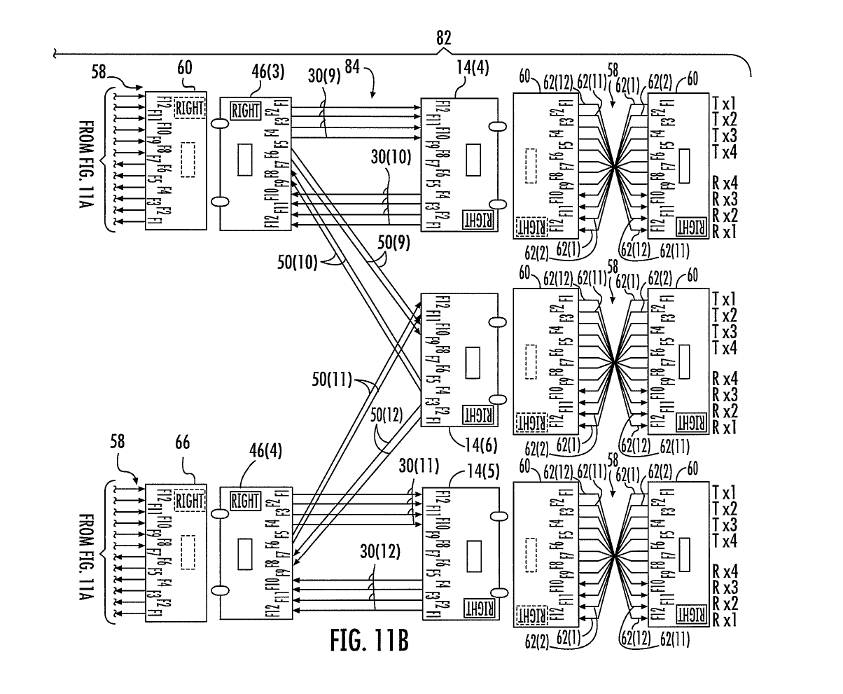

The tap conversion assembly 44 of FIG. 6 may also be used to integrate monitoring functions into an active fiber optic network. In this regard, FIGS. 11A and 11B disclose a portion of a network 82 using a tap conversion assembly 44 to convert between three Base-8 fiber positions on one side of the tap conversion assembly 44 and two live Base-12 fiber positions and two tap Base-12 fiber positions on the other. A conversion assembly 84 is also connected to the two Base-12 fiber positions. The conversion assembly 84 is able to convert between the two live Base-12 positions on one side and three Base-8 positions on the other. In this manner, a large number of Base-8 components can use the network 82 while requiring a relatively smaller amount of rack space within some portions of the network 82 where higher connection density is desired, such as at a switch.

In this regard, FIGS. 11A and 11B disclose the tap conversion assembly 44 (shown in FIG. 11A) with jumper cables 58 attached to each of live Base-8 connectors 14(1)-14(3), and a pair of jumper cables 58 extending from live Base-12 connector 46(2) to connect to live Base-12 connectors 46(3) and 46(4) on one side of conversion assembly 84 (shown in FIG. 11B). The conversion assembly 84 has three Base-8 connectors 14(4)-14(6) on the other side, each connected to a respective jumper cable 58. The Base-12 to Base-8 conversion of conversion assembly 84 is symmetrical to the conversion of tap conversion assembly 44, with ninth and tenth groups of live optical fibers 30(9) and 30(10) being connected between live multi-fiber connectors 14(4) and 46(3), eleventh and twelfth groups of live optical fibers 30(11) and 30(12) being connected between live multi-fiber connectors 14(5) and 46(4), ninth and tenth pairs of live optical fibers 50(9) and 50(10) being connected between live multi-fiber connectors 14(6) and 46(3), and eleventh and twelfth pairs of live optical fibers 50(11) and 50(12) being connected between live multi-fiber connectors 14(6) and 46(4).

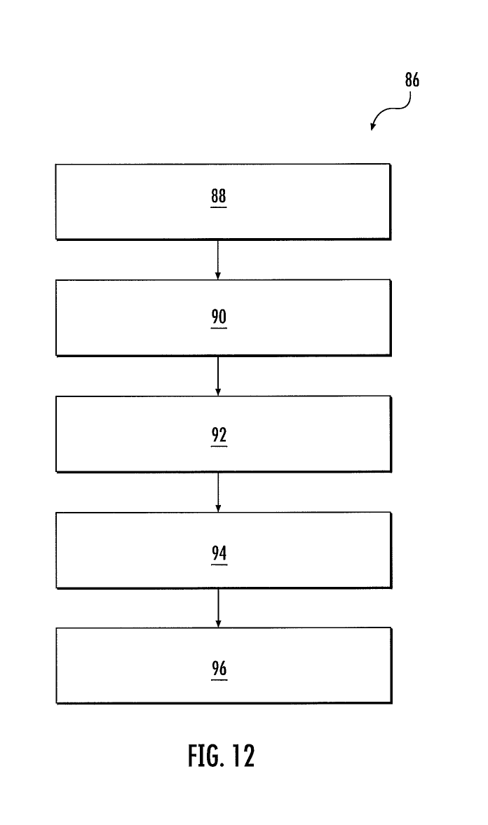

Thus, it can be seen that tap connections may be integrated into any number of network configurations via assemblies, including the assemblies and methods disclosed and contemplated herein. In this regard, FIG. 12 illustrates a flowchart 86 of an exemplary method of routing live and tap fiber optic signals using a parallel optical connection configuration. First, a first plurality of live optical input signals is received at a first plurality of live output fiber positions of a fiber optic assembly in a parallel optical connection configuration (block 88). A second plurality of live optical input signals is also received at a second plurality of live output fiber positions of the fiber optic assembly in a parallel optical connection configuration (block 90). The method further comprises splitting the first plurality of live optical input signals into a first plurality of live optical output signals and a first plurality of tap optical output signals (block 92). The method further comprises providing the first plurality of live optical output signals to a second live optical component of the fiber optic assembly in a parallel optical connection configuration (block 94). The method further comprises providing the plurality of tap optical output signals from at least one tap optical component of the fiber optic assembly in a parallel optical connection configuration (block 96). It should be understood that this and other method steps may be performed in sequence or simultaneously, as desired.

It should be noted that any of the fiber optic assemblies can be provided in a fiber optic module, a fiber optic cable, or any other type of fiber optic device or enclosure, as desired. It should also be noted that alternative fiber optic connection components having fiber connection positions may be substituted for the fiber optic connectors, including the above described live multi-fiber connectors and/or tap multi-fiber connectors, as desired. Any optical connection discussed herein is not limited to a direct connection. The optical connections disclosed herein between two components or devices may involve a direct or indirect optical connection. Any fiber optic connectors disclosed herein may involve the use of lenses, including but not limited to gradient indexed (GRIN) lenses, for providing optical paths and establishing optical connections.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A fiber optic assembly for supporting optical connections in a fiber optic network, comprising:
a first live multi-fiber component having a first plurality of live input fiber positions;
a second live multi-fiber component having a second plurality of live output fiber positions optically connected to the first plurality of live input fiber positions; and
at least one tap multi-fiber component having a first plurality of tap input fiber positions optically connected to the second plurality of live output fiber positions having a parallel optical connection configuration therebetween.

2. The fiber optic assembly according to claim 1, wherein:
the first live multi-fiber component further comprises a first plurality of live output fiber positions;
the second live multi-fiber component further comprises a second plurality of live input fiber positions optically connected to the first plurality of live output fiber positions; and
the at least one tap multi-fiber component further comprises a second plurality of tap input fiber positions optically connected to the second plurality of live output fiber positions having a parallel optical connection configuration therebetween.

3. The fiber optic assembly of claim 2 disposed in a fiber optic module.

4. The fiber optic assembly of claim 2, wherein:
the first live multi-fiber component is a first live multi-fiber connector;
the second live multi-fiber component is a second live multi-fiber connector; and
each of the at least one tap multi-fiber component is a tap multi-fiber connector.

5. The fiber optic assembly of claim 4, wherein:
the first live multi-fiber connector and a second tap multi-fiber connector are disposed in a first side of an enclosure; and
the second live multi-fiber connector and a first tap multi-fiber connector are disposed in a second side of the enclosure opposite the first side.

6. The fiber optic assembly of claim 4, wherein:
the first live multi-fiber connector is received by a first live multi-fiber adapter;
the second live multi-fiber connector is received by a second live multi-fiber adapter; and
the tap multi-fiber connector is received by at least one tap multi-fiber adapter.

7. The fiber optic assembly of claim 2, further comprising:
a first plurality of optical splitters and a second plurality of optical splitters each having a live input, a live output and a tap output;
a first plurality of live optical fibers connected between the live input of the first plurality of optical splitters and the first plurality of live output fiber positions;
a second plurality of live optical fibers connected between the live outputs of the first plurality of optical splitters and the second plurality of live input fiber positions;
a third plurality of live optical fibers connected between the live inputs of the second plurality of optical splitters and the second plurality of live output fiber positions;
a fourth plurality of live optical fibers connected between the live outputs of the second plurality of optical splitters and the first plurality of live input fiber positions;
a first plurality of tap optical fibers connected between the tap outputs of the first plurality of optical splitters and the first plurality of tap input fiber positions of one of the at least one tap multi-fiber component; and
a second plurality of tap optical fibers connected between the tap outputs of the first plurality of optical splitters and the second plurality of tap input fiber positions of one of the at least one tap multi-fiber component.

8. The fiber optic assembly of claim 7, wherein the first plurality of live input fiber positions and the first plurality of live output fiber positions of the first live multi-fiber component have a first parallel optical configuration having a plurality of fiber positions such that one half of the plurality of fiber positions is the first plurality of live input fiber positions and another half of the plurality of fiber positions is the first plurality of live output fiber positions;
the second plurality of live input fiber positions and the second plurality of live output fiber positions of the second live multi-fiber component have the first parallel optical configuration having a plurality of fiber positions such that one half of the plurality of fiber positions is the second plurality of live input fiber positions and another half of the plurality of fiber positions is the second plurality of live output fiber positions;
the first plurality of tap input fiber positions of one of the at least one tap multi-fiber component has the first parallel optical configuration having a plurality of fiber positions such that one half of the plurality of fiber positions is the first plurality of tap input fiber positions; and
the second plurality of tap input fiber positions of one of the at least one tap multi-fiber component has the first parallel optical configuration having a plurality of fiber positions such that one half of the plurality of fiber positions is the second plurality of tap input fiber positions.

9. The fiber optic assembly of claim 8, wherein a first plurality of fiber positions corresponding to one half of the plurality of fiber positions and a second plurality of fiber positions corresponding to another half of the plurality of fiber positions have an equal number of fiber positions.

10. The fiber optic assembly of claim 9, wherein each of the first and second pluralities of optical splitters has a number of optical splitters equal to the number of fiber positions in each of the first and second pluralities of fiber positions.

11. The fiber optic assembly of claim 9, wherein each of the first, second, third, and fourth plurality of live optical fibers has a number of live optical fibers equal to the number of fiber positions in each of the first and second pluralities of fiber positions; and
each of the first and second pluralities of tap optical fibers has a number of tap optical fibers equal to the number of fiber positions in the first and second pluralities of fiber positions.

12. The fiber optic assembly of claim 9, wherein each of the first and second pluralities of fiber positions consists of four (4) fiber positions.

13. The fiber optic assembly of claim 9, wherein each of the first and second pluralities of fiber positions consists of six (6) fiber positions.

14. The fiber optic assembly of claim 9, wherein the first parallel optical configuration is part of a second parallel optical configuration comprising the first and second pluralities of fiber positions of the first parallel optical configuration, a third plurality of fiber positions and a fourth plurality of fiber positions; and
each of the third and fourth pluralities of fiber positions has a number of fiber positions equal to half the number of fiber positions in each of the first and second pluralities of fiber positions.

15. The fiber optic assembly of claim 14, wherein each of the first and second pluralities of fiber positions consists of four (4) fiber positions; and
each of the third and fourth pluralities of fiber positions consists of two (2) fiber positions.

16. The fiber optic assembly of claim 15, wherein the second parallel optical configuration is compatible with a multi-fiber connector having twelve (12) fiber positions, wherein:
the first plurality of fiber positions corresponds to fiber positions 1-4 of the multi-fiber connector;
the second plurality of fiber positions corresponds to fiber positions 9-12 of the multi-fiber connector;
the third plurality of fiber positions corresponds to fiber positions 5 and 6 of the multi-fiber connector; and
the fourth plurality of fiber positions corresponds to fiber positions 7 and 8 of the multi-fiber connector.

17. The fiber optic assembly of claim 16, wherein the multi-fiber connector is one of an MPO and an MTP connector.

18. The fiber optic assembly of claim 14, wherein the second parallel optical configuration is compatible with a multi-fiber connector having twelve (12) fiber positions, wherein:
the first plurality of fiber positions corresponds to fiber positions 1-4 of the multi-fiber connector; and
the second plurality of fiber positions corresponds to fiber positions 9-12 of the multi-fiber connector.

19. The fiber optic assembly of claim 18, wherein the multi-fiber connector is one of an MPO and an MTP connector.

20. The fiber optic assembly of claim 11, wherein:
the first plurality of live optical fibers is connected between the live inputs of the first plurality of optical splitters and the second plurality of fiber positions of the first live multi-fiber component;
the second plurality of live optical fibers is connected between the live outputs of the first plurality of optical splitters and the second plurality of fiber positions of the second live multi-fiber component;
the third plurality of live optical fibers is connected between the live inputs of the second plurality of optical splitters and the first plurality of fiber positions of the second live multi-fiber component; and
the fourth plurality of live optical fibers is connected between the live outputs of the second plurality of optical splitters and the first plurality of fiber positions of the first live multi-fiber component.

21. The fiber optic assembly of claim 20, wherein:
the first plurality of tap optical fibers is connected between the tap outputs of the first plurality of optical splitters and one of the first and second pluralities of fiber positions of a first tap multi-fiber component of the at least one tap multi-fiber component; and
the second plurality of tap optical fibers is connected between the tap outputs of the first plurality of optical splitters and one of the first and second pluralities of fiber positions of a second tap multi-fiber component of the at least one tap multi-fiber component.

22. The fiber optic assembly of claim 20, wherein:
the first plurality of tap optical fibers is connected between the tap outputs of the first plurality of optical splitters and the second plurality of fiber positions of a first tap multi-fiber component of the at least one tap multi-fiber component; and
the second plurality of tap optical fibers is connected between the tap outputs of the first plurality of optical splitters and the second plurality of fiber positions of a second tap multi-fiber component of the at least one tap multi-fiber component.

23. The fiber optic assembly of claim 20, wherein:
the first plurality of tap optical fibers is connected between the tap outputs of the first plurality of optical splitters and one of the first and second pluralities of fiber positions of a first tap multi-fiber component of the at least one tap multi-fiber component; and
the second plurality of tap optical fibers is connected between the tap outputs of the first plurality of optical splitters and the other of the first and second pluralities of fiber positions of the first tap multi-fiber component.

24. The fiber optic assembly of claim 20, wherein:
the first plurality of tap optical fibers is connected between the tap outputs of the first plurality of optical splitters and the second plurality of fiber positions of a first tap multi-fiber component of the at least one tap multi-fiber component; and
the second plurality of tap optical fibers is connected between the tap outputs of the first plurality of optical splitters and the first plurality of fiber positions of the first tap multi-fiber component.

25. The fiber optic assembly of claim 24, further comprising an enclosure, wherein
the first live multi-fiber component is disposed in a first side of the enclosure; and
the second live multi-fiber component and the first tap multi-fiber component are disposed in a second side of the enclosure opposite the first side.

26. The fiber optic assembly of claim 11, wherein:
the first plurality of live optical fibers is connected between the live inputs of the first plurality of optical splitters and the first plurality of fiber positions of the first live multi-fiber component;
the second plurality of live optical fibers is connected between the live outputs of the first plurality of optical splitters and the second plurality of fiber positions of the second live multi-fiber component;
the third plurality of live optical fibers is connected between the live inputs of the second plurality of optical splitters and the first plurality of fiber positions of the second live multi-fiber component; and
the fourth plurality of live optical fibers is connected between the live outputs of the second plurality of optical splitters and the second plurality of fiber positions of the first live multi-fiber component.

27. The fiber optic assembly of claim 26, wherein:
the first plurality of tap optical fibers is connected between the tap outputs of the first plurality of optical splitters and one of the first and second pluralities of fiber positions of a first tap multi-fiber component of the at least one tap multi-fiber component; and
the second plurality of tap optical fibers is connected between the tap outputs of the second plurality of optical splitters and one of the first and second pluralities of fiber positions of a second tap multi-fiber component of the at least one tap multi-fiber component.

28. The fiber optic assembly of claim 26, wherein:
the first plurality of tap optical fibers is connected between the tap outputs of the first plurality of optical splitters and the second plurality of fiber positions of a first tap multi-fiber component of the at least one tap multi-fiber component; and
the second plurality of tap optical fibers is connected between the tap outputs of the second plurality of optical splitters and the second plurality of fiber positions of a second tap multi-fiber component of the at least one tap multi-fiber component.

29. The fiber optic assembly of claim 28, further comprising an enclosure, wherein the first live multi-fiber component and the second tap multi-fiber component are disposed in a first side of the enclosure; and
the second live multi-fiber component and the first tap multi-fiber component are disposed in a second side of the enclosure opposite the first side.

30. The fiber optic assembly of claim 26, wherein:
the first plurality of tap optical fibers is connected between the tap outputs of the first plurality of optical splitters and one of the first and second pluralities of fiber positions of a first tap multi-fiber component of the at least one tap multi-fiber component; and
the second plurality of tap optical fibers is connected between the tap outputs of the first plurality of optical splitters and the other of the first and second pluralities of fiber positions of the first tap multi-fiber component.

31. The fiber optic assembly of claim 26, wherein:
the first plurality of tap optical fibers is connected between the tap outputs of the first plurality of optical splitters and the second plurality of fiber positions of a first tap multi-fiber component of the at least one tap multi-fiber component; and
the second plurality of tap optical fibers is connected between the tap outputs of the first plurality of optical splitters and the first plurality of fiber positions of the first tap multi-fiber component.

32. The fiber optic assembly of claim 31, further comprising an enclosure, wherein the first live multi-fiber component is disposed in a first side of the enclosure; and
the second live multi-fiber component and the first tap multi-fiber component are disposed in a second side of the enclosure opposite the first side.

33. A method of routing live and tap optical signals in a parallel optical configuration comprising:
receiving a first plurality of live optical input signals at a first plurality of live output fiber positions of a first live multi-fiber component of a fiber optic assembly in a parallel optical connection configuration;
splitting the first plurality of live optical input signals into a first plurality of live optical output signals and a first plurality of tap optical output signals;
providing the first plurality of live optical output signals to a second plurality of live input fiber positions of a second live optical component of the fiber optic assembly in a parallel optical connection configuration; and
providing the first plurality of tap optical output signals to a first plurality of tap input fiber positions of at least one tap optical component of the fiber optic assembly in a parallel optical connection configuration.

34. The method of claim 33, further comprising:
receiving a second plurality of live optical input signals at a second plurality of live output fiber positions of the second live multi-fiber component of the fiber optic assembly in a parallel optical connection configuration;
splitting the second plurality of live optical input signals into a second plurality of live optical output signals and a second plurality of tap optical output signals;
providing the second plurality of live optical output signals to a first plurality of live input fiber positions of the first live optical component of the fiber optic assembly in a parallel optical connection configuration; and
providing the second plurality of tap optical output signals to a second plurality of tap input fiber positions of the at least one tap optical component of the fiber optic assembly in a parallel optical connection configuration.
